(19) United States
(12) Patent Application Publication
(10) Pub. No.: US 2013/0124511 A1
(43) Pub. Date: May 16, 2013

(54) VISUAL SEARCH HISTORY

(71) Applicants: Noah Levin, San Francisco, CA (US); Peter Jin Hong, San Francisco, CA (US)

(72) Inventors: Noah Levin, San Francisco, CA (US); Peter Jin Hong, San Francisco, CA (US)

(21) Appl. No.: 13/676,230

(22) Filed: Nov. 14, 2012

Related U.S. Application Data
(60) Provisional application No. 61/559,468, filed on Nov. 14, 2011.

(51) Int. Cl. G06F 17/30

(52) U.S. Cl. 707/723; 707/E17.082

(57) ABSTRACT

Methods, systems, and apparatus, including computer programs encoded on a computer storage medium, for presenting a visual search history. Presentation data is received indicating that a resource has been presented by a user device, the resource having been presented in response to user interaction with a search result that referenced the resource. In response to receipt of the presentation data, an image of the resource is acquired. The acquired image is associated with a search query for which the search result was provided. In response to receipt of a request for a search history for the user device, the acquired image and the associated search query are displayed.

### CROSS-REFERENCE TO RELATED APPLICATION

This application claims priority of U.S. Provisional Application No. 61/559,468, filed Nov. 14, 2011, the entirety of which is hereby incorporated by reference as if fully set forth therein.

### BACKGROUND

This specification relates to data processing and information retrieval.

The Internet provides access to a wide variety of resources such as images, video or audio files, web pages for particular subjects, book articles, or news articles. A search system can identify resources in response to a search query that includes one or more search terms or phrases. The search system ranks the resources based on their relevance to the query and on measures of quality of the resources and provides search results that link to the identified resources. The search results are typically ordered for viewing according to the rank.

A user may later wish to review their search history and return to a resource that was previously accessed. If the user cannot remember the name or web address of the search result, the user may not be able to quickly locate and return to the resource. Thus, the user may experience difficulty in obtaining information that can help the user satisfy his or her informational need.

### SUMMARY

In general, one innovative aspect of the subject matter described in this specification can be embodied in methods that include the actions of receiving presentation data indicating that a resource has been presented by a user device, the resource having been presented in response to user interaction with a search result that referenced the resource; in response to receipt of the presentation data, acquiring an image of the resource; associating the acquired image with a search query for which the search result was provided; receiving a request for a search history for the user device; and in response to receipt of the request, displaying the acquired image and the associated search query. Other embodiments of this aspect include corresponding systems, apparatus, and computer programs, configured to perform the actions of the methods, encoded on computer storage devices.

These and other embodiments can each optionally include one or more of the following features. Methods can further include the actions of receiving additional presentation data indicating that an additional resource has been presented by the user device; in response to receipt of the additional presentation data, acquiring an additional image of the additional resource; associating the additional image with the search query; and in response to receipt of the request, displaying a visual grouping of images associated with the search query, the visual grouping including the acquired image and a graphic indicative of the additional image. In response to user interaction with the visual grouping of images, at least the acquired and additional images can be displayed individually. . . .

Methods can further include the actions of receiving history interaction data indicating that user interaction with the acquired image has occurred; in response to receipt of the history interaction data: increasing a presentation size of the acquired image; and rendering at least a portion of the resource; determining that at least a threshold portion of the resource has been rendered; and in response to the determination, replacing the image with the resource. Methods can further include the action of modifying the image to be visually distinct from the rendered resource.

Receiving a request for the search history can include determining that a user swipe occurred during a presentation of search results, the determination that the user swipe has occurred being based, at least in part, on detection of a pointer at multiple locations along a path that extends from a first display location to a second display location.

Methods can further include the actions of determining that the resource was fully rendered and presented by the user device. Receiving the presentation data can include receiving the presentation data in response to the determination that the resource was fully rendered and presented by the user device.

Particular embodiments of the subject matter described in this specification can be implemented so as to realize one or more of the following advantages. Images of resources can be generated and indexed on a per-resource basis, and each resource can be stored in relation to the search query that resulted in the resource being selected. Presenting the user with images rather than text in order to find previously-visited sites may increase the ease of recognition and facilitate easier return to those sites. Acquiring and storing images based on the actual rendered content of the resource allows for reproducing what the user actually saw when the resource was originally displayed, and makes reduces the need for the device to request or render resources while the user browses search history. Grouping the images according to search query supports quicker browsing through different search queries, while expanding each group allows for each individual resource to be represented by its own image.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a search system provides search services.

FIG. 2 is a screen shot of an example search results page.

FIGS. 3A-3C are screen shots of an example visual search history presentation.

FIGS. 3D-3G are screen shots of an image enlarged and presented to a user in place of a resource.

FIG. 4 is a flow chart of an example process for presenting a visual search history.

FIG. 5 is block diagram of an example computer system.

Like reference numbers and designations in the various drawings indicate like elements.

### DETAILED DESCRIPTION

A visual search history is provided to a user. The visual search history associates each web page previously visited with an image of that web page, obtained at the time that the website was last rendered to display to the user. The user can scroll through the images to find a web page previously visited, and can return to the page by selecting it.

Each web page is associated with the search query for which the web page was identified as responsive. In some implementations, a “stack” graphic may be used to indicate that a group of several images are available for a particular query, where each image represents a web page that was referenced by a search result that was 1) generated for that search query and 2) visited by the user. User interaction with the “stack graphic” may cause presentation of the individual images.

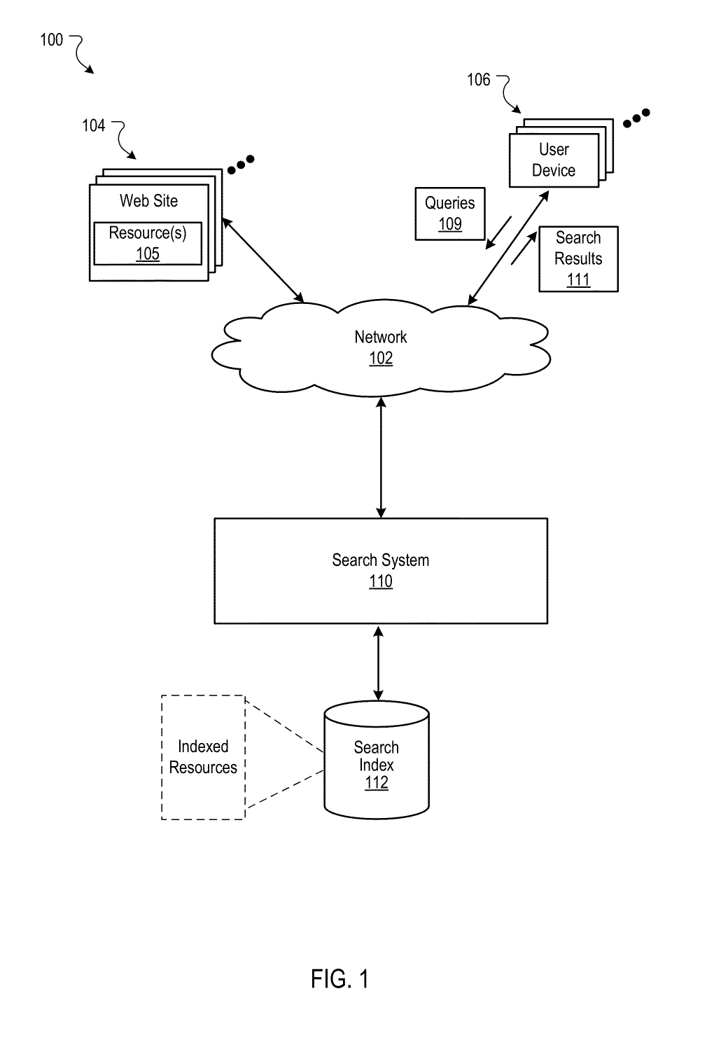

FIG. 1 is a block diagram of an example environment 100 in which a search system 110 provides search services. The example environment 100 includes a network 102, e.g., a local area network (LAN), wide area network (WAN), the Internet, or a combination of them, connects web sites 104, user devices 106, and the search system 110. The environment 100 may include many thousands of web sites 104 and user devices 106.

A web site 104 is one or more resources 105 associated with a domain name and hosted by one or more servers. An example web site is a collection of web pages formatted in hypertext markup language (HTML) that can contain text, images, multimedia content, and programming elements, e.g., scripts. Each web site 104 is maintained by a publisher, e.g., an entity that manages and/or owns the web site.

A resource 105 is any data that can be provided by a web site 104 over the network 102 and that is associated with a resource address. Resources 105 include HTML pages, word processing documents, and portable document format (PDF) documents, images, video, and feed sources, to name just a few. The resources 105 can include content, e.g., words, phrases, images and sounds and may include embedded information (e.g., meta information and hyperlinks) and/or embedded instructions (e.g., scripts).

A user device 106 is an electronic device that is under control of a user and is capable of requesting and receiving resources 105 over the network 102. Example user devices 106 include personal computers, mobile communication devices, tablet computing devices, and other devices that can send and receive data over the network 102. A user device 106 typically includes a user application, e.g., a web browser, to facilitate the sending and receiving of data over the network 102.

To facilitate searching of resources 105, the search system 110 identifies the resources 105 by crawling and indexing the resources 105 provided on web sites 104. Data about the resources 105 can be indexed based on the resource to which the data corresponds. The indexed and, optionally, cached copies of the resources 105 are stored in a search index 112.

The user devices 106 submit search queries 109 to the search system 110. In response, the search system 110 accesses the search index 112 to identify resources 105 that are relevant to (e.g., have at least a minimum specified relevance score for) the search query 109. The search system 110 identifies the resources 105, generates search results 111 that identify the resources 105, and returns the search results 111 to the user devices 106. A search result 111 is data generated by the search system 110 that identifies a resource 105 that is responsive to a particular search query, and includes a link to the resource 105. An example search result 111 can include a web page title, a snippet of text or a portion of an image extracted from the web page, and the URL of the web page.

For a search of textual content, the search results are ranked based, at least in part, on scores related to the resources 105 identified by the search results 111, such as information retrieval (“IR”) scores, and optionally a quality score of each resource relative to other resources. In some implementations, the IR scores are computed from dot products of feature vectors corresponding to a search query 109 and a resource 105, and the ranking of the search results is based on initial relevance scores that are a combination of the IR scores and page quality scores. The search results 111 are ordered according to these initial relevance scores and provided to the user device 106 according to the order.

The user devices 106 receive the search results 111, e.g., in the form of one or more web pages, and render the search results for presentation to users. In response to the user interacting with (e.g., affirmatively selecting or hovering over) a link in a search result at a user device 106, the user device 106 requests the resource 105 identified by the link. For brevity, this document refers to user interactions with search results as clicks of links, but user interactions are not limited to clicks. For example, a user touching a touch screen at a location at which a search result is presented is considered a user interaction with the search result. Also, a pointer being “hovered” over a target for more than a threshold amount of time can be considered user interaction with the target. The web site 104 hosting the resource 105 receives the request for the resource from the user device 106 and provides the resource 105 to the requesting user device 106.

The user device 106 renders and displays the resource 105 to the user. The device 106 also creates an image of the resource 105, which may be a screen-shot of a web page. The image depicts the appearance of the resource 105 as displayed to the user. The image may then be included in an index of explored search results (e.g., search results with which a user interacted) associated with the search query for which the result was generated. Images associated with retrieved resources may be stored locally on the user device 106, remotely in conjunction with the search system 110, or some combination of the two.

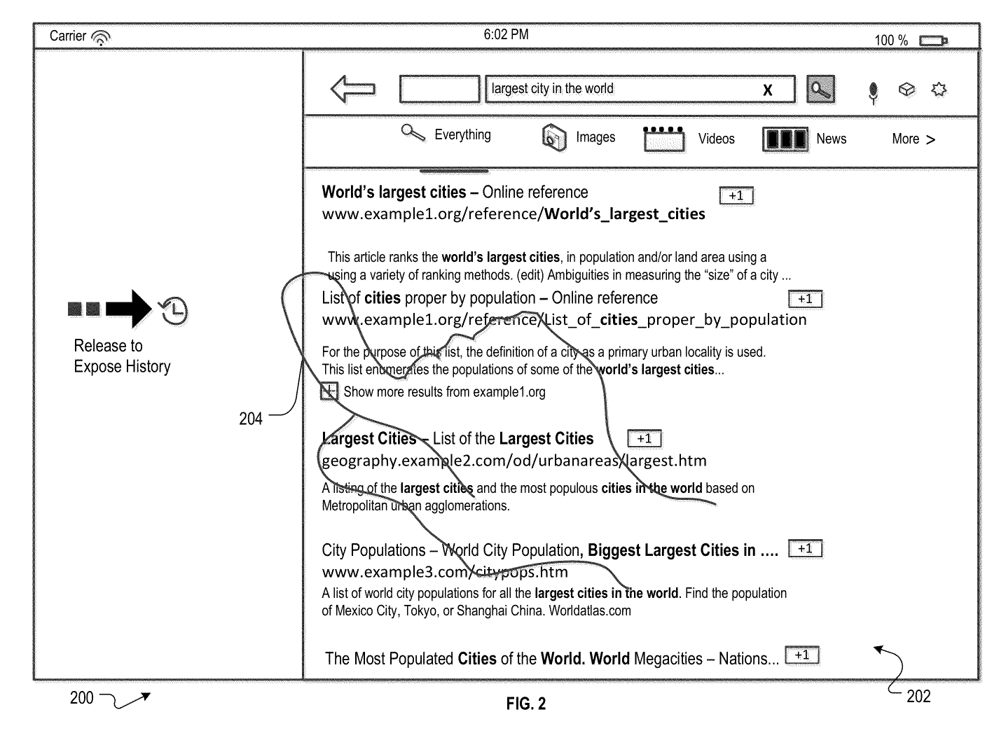

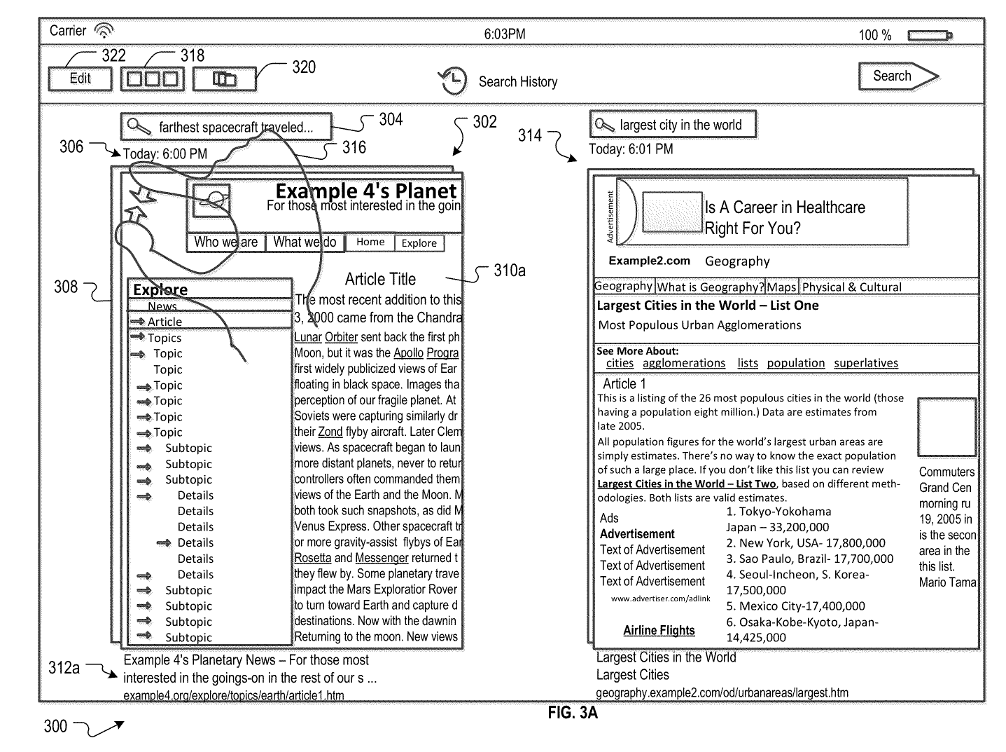

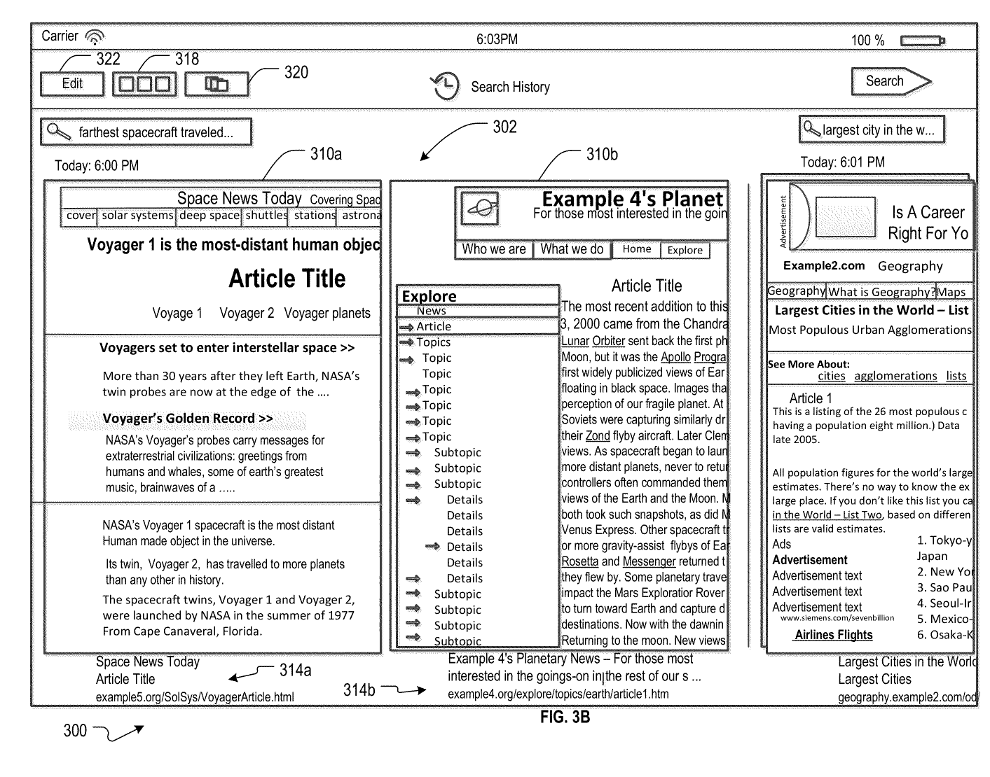

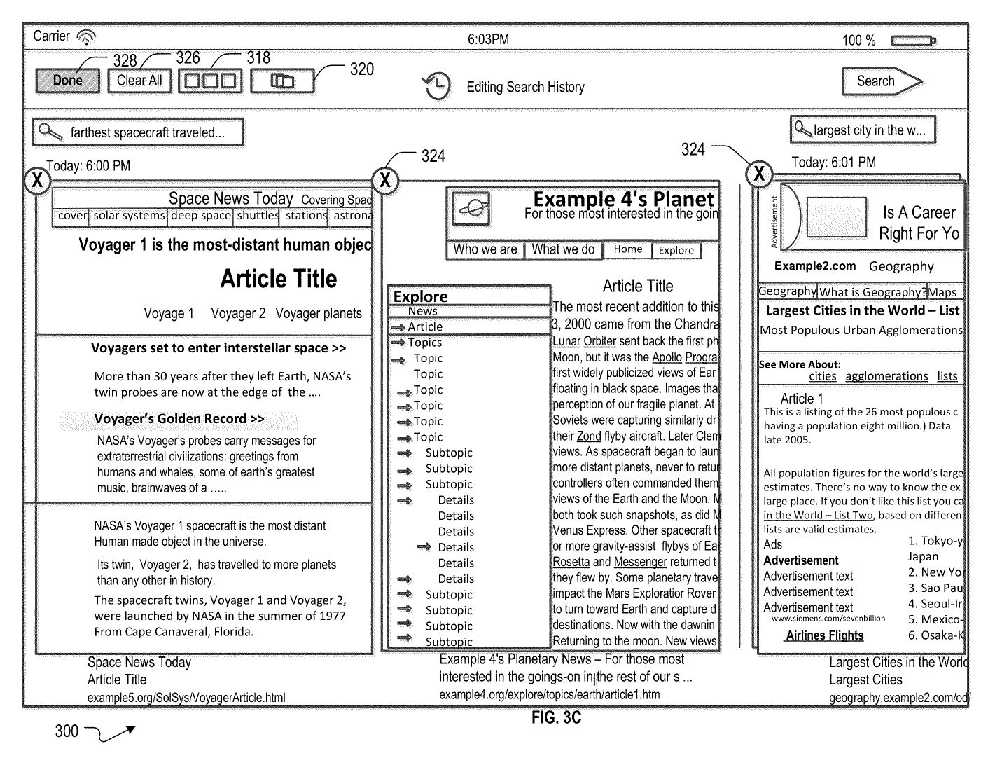

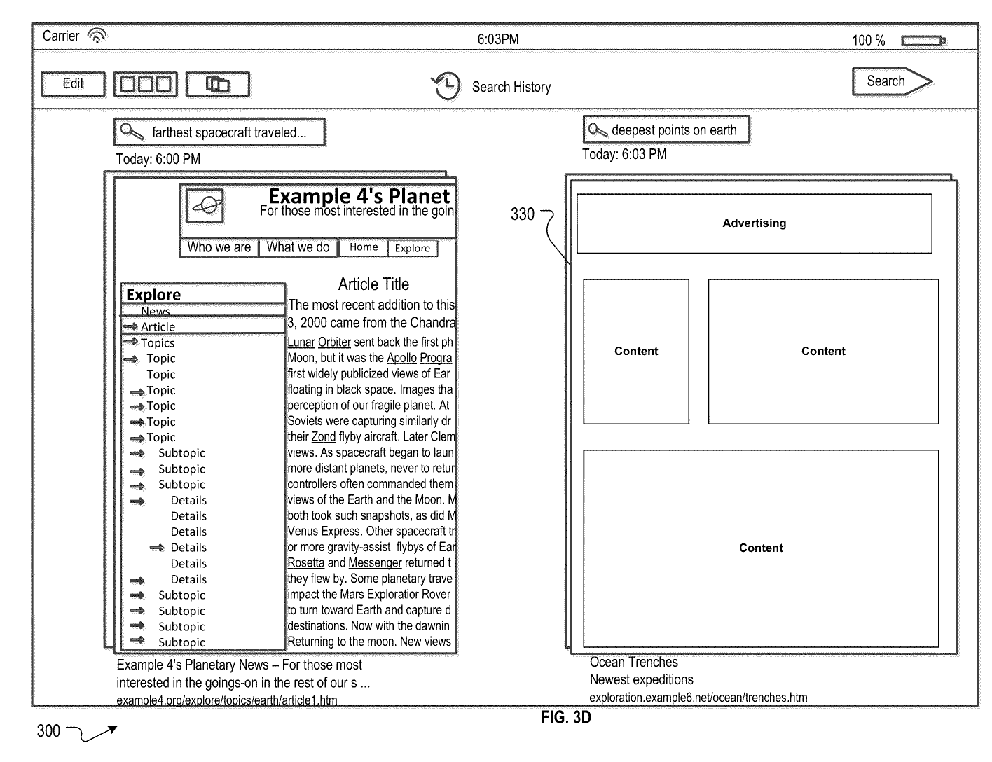

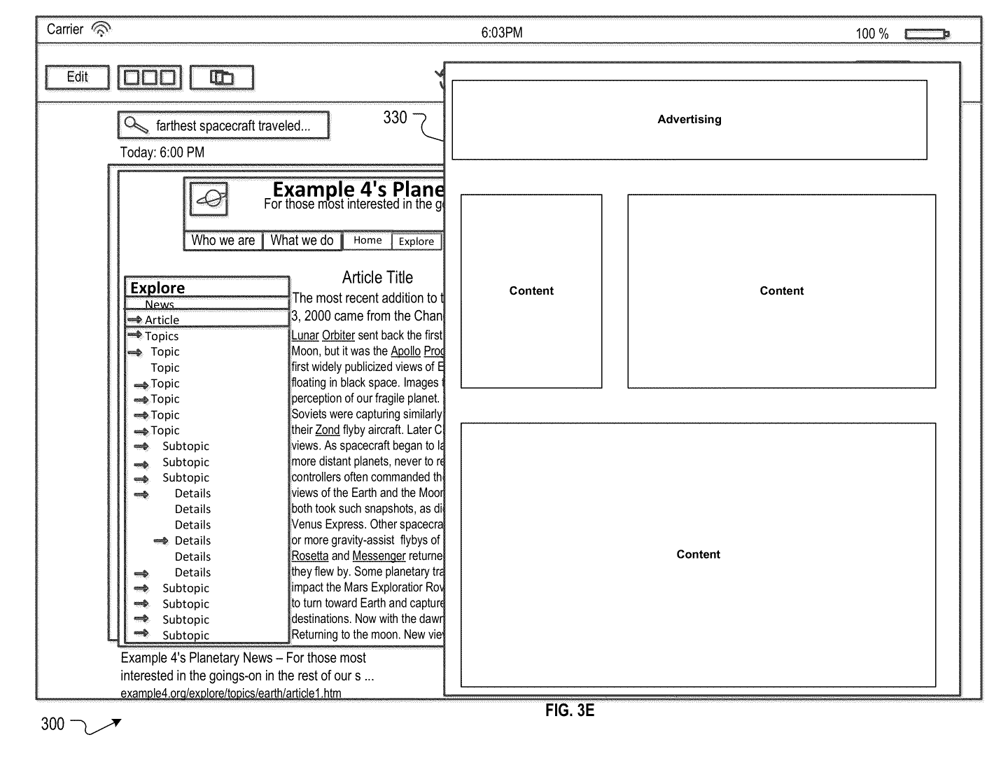

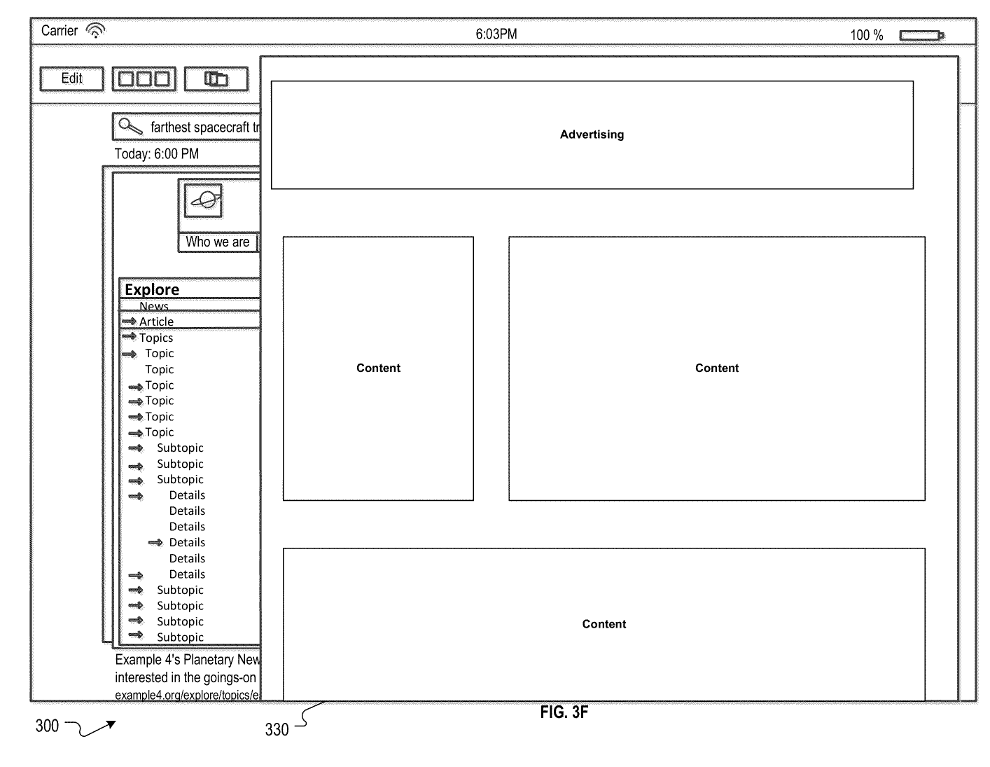

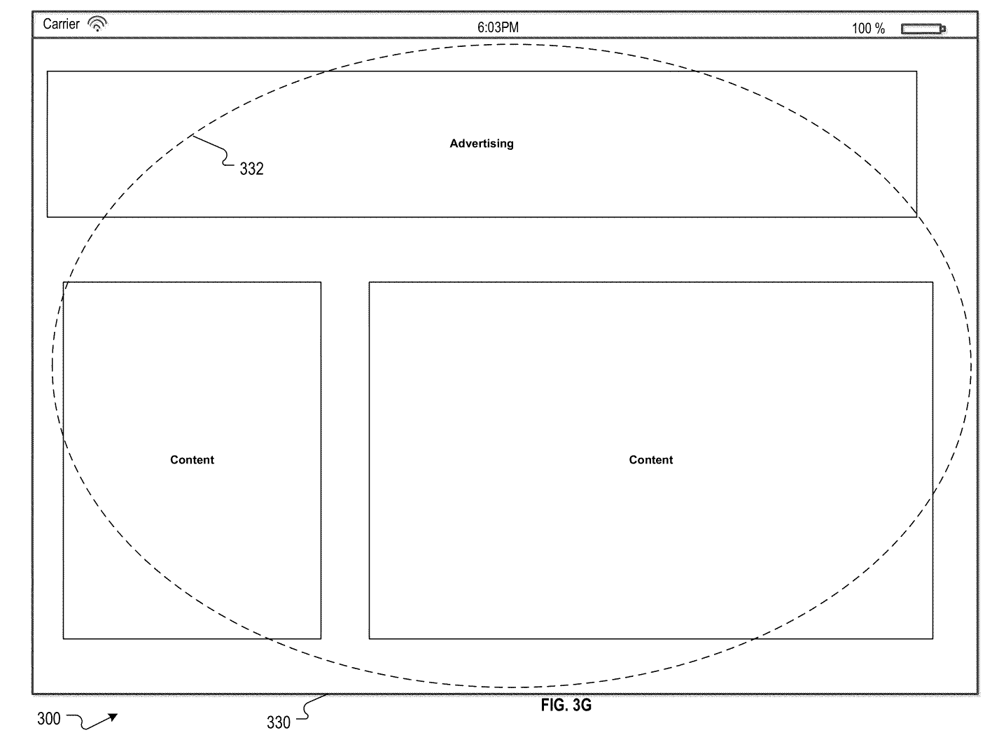

These stored images may be used to generate a visual search history, as illustrated in FIGS. 3A-3C. FIG. 2 shows a touch-screen user device 200 upon which is displayed a search results page 202. Swiping from the left edge of the page 202 to the right as shown by the action of the user's hand 204 may reveal a visual search history display 300, shown in FIG. 3A. Here, images of previously requested resources are grouped according to search query. A first search query group 302 includes a search query button 304 showing the search query with which the group 302 is associated. User interaction with the search query button 304 causes submission of the search query to the search system, and the search results page for the search query that is listed on the button 304 can be presented to the user.

Below the button 304 is a timestamp 306 that indicates when this particular search query was most recently entered by the user. This timestamp may instead be based on other events, such as the last time the device responded to a user interaction with a search result associated with this query or the last time the search results page was presented to the user, whether or not the query was resubmitted to the search system. In some implementations, further submissions or re-submissions of the same search query may be shown as separate search query groups, with separate timestamps and distinct results histories; in other implementations, explored results associated with the same search query are aggregated and the timestamp updated when a search is re-run.

A stack graphic 308 represents the record of multiple resources associated with the search query group 302. A top image 310a on the stack is visible, representing a first specific resource. A caption 312a below the graphic 308 shows a title and web address of the resource associated with the top image 310a. Images representing resources may be ordered in a number of different ways, including placing the first visited or most recently visited result on top, placing on top the visited result that ranked highest on the search results page, or even alphabetizing the web addresses or titles. A second search query group 314 has similar features. Additional query groups may be available by horizontal scrolling (e.g., swiping across the display from left to right or right to left).

As illustrated by FIG. 3A, the client device 200 can change the manner in which a search history is presented, for example, in response to detecting user interaction with the search history. For example, when the client device 200 detects a user's hand 316 (or another pointer) interacting with the stack graphic 308 in a predefined way (such as pinching the corner, as shown), the client device 200 can replace the stack graphic 308 with individual images, as shown in FIG. 3B. Here, the search query group 302 has been expanded to show multiple images 310a, 310b each associated with a different resource. Each image representing a resource also includes its own caption 314a, 314b giving the title and web address of that resource. When the client device 200 detects user interaction with an image the client device 200 can again request the resource and then render and display the resource to the user as described above. Grouping and ungrouping the resources listed under each search query can also be performed in response to user interaction with buttons 318, 320.

As further illustrated in FIG. 3C, the client device 200 may be configured to selectively maintain items within the search history, such that a user can eliminate records from the search history and/or prevent records from being included in the search history. For example, upon user interaction with an “Edit” button 322 shown in FIGS. 3A and 3B, the display 300 modifies to include edit capabilities as shown. Single results, or full stacks of results representing search query groups, can be deleted with the use of delete buttons 324 adjacent to the images of records to be deleted. User interaction with a “Clear All” button 326 may eliminate all search history records (but may first require the user to confirm the “Clear All” with an additional dialog box). User interaction with the “Done” button 328 eliminates the edit-specific display elements 324, 326 and returns the display 300 to what is shown in FIG. 3A or 3B.

It may also be optional as to whether the device maintains a record of search results. For example, the client device 200 may be configured such that a user may be able to elect to turn off search history. If the user elects to turn the search history off, further searches and resources followed from those searches will not be recorded. However, turning off search history may not automatically delete previously-recorded search history, such that a user can selectively choose to not record search history during specific sessions while still maintaining search history generated during other sessions. These options may be available to the user through a search options page, on the search history page, or on the search page itself. The device may also selectively present dialog boxes prompting the user to select whether to record search history. In some implementations, such dialog boxes may be presented the first time (e.g., during a particular browsing session) the device presents search results to the user and at further intervals measured by number of sessions, by number of queries submitted, by number of resources presented, by elapsed time, or any combination of these.

In some implementations, when a user selects an image in order to return to the resource represented by the image, the image is presented as a placeholder while the resource is rendered. The image may be enlarged to substantially fill the display, sized and positioned similarly to how the rendered resource will appear. When a certain rendering threshold is reached for the rendering of the resource (e.g., 50% of the resource rendered or a pre-specified time elapsing), the rendered resource displaces the image on the display. Until that time, there may be some alteration of the image, such as a differing border around the image or a change in brightness or color, to indicate to the user that what is displayed is an image and that the actual resource, along with hyperlinks and/or other interactive features the resource includes, is not yet displayed.

FIG. 3D shows a search history page 300 including an image 330 associated with a previously accessed resource. Upon user interaction with the image 330, such as a click, the device uses animation to present the image as expanding to fill the page. FIGS. 3E and 3F show the image 330 enlarged and filling a greater area of the page as time elapses. FIG. 3G shows the image 330 enlarged and being presented in substantially the same position as the resource that it represents.

In some implementations, other animation features may be included in the page transition. For example, the image may appear to lift off of the search history page and move to land in a browser window or other search client interface. This animation takes time to complete, giving the device additional time to render the resource and reducing the amount of time that the user is presented with the image replacement.

In some implementations, a variety of filters may be applied to the image to differentiate it from the rendered resource. The resource may be substantially altered, for example, in the area outside of the broken line 332 using brightening, smearing, or other processing in order to better present the nature of the image. The replacement of the image 330 with the associated resource is thus visually indicated by the absence of these modifications in displaying the rendered resource.

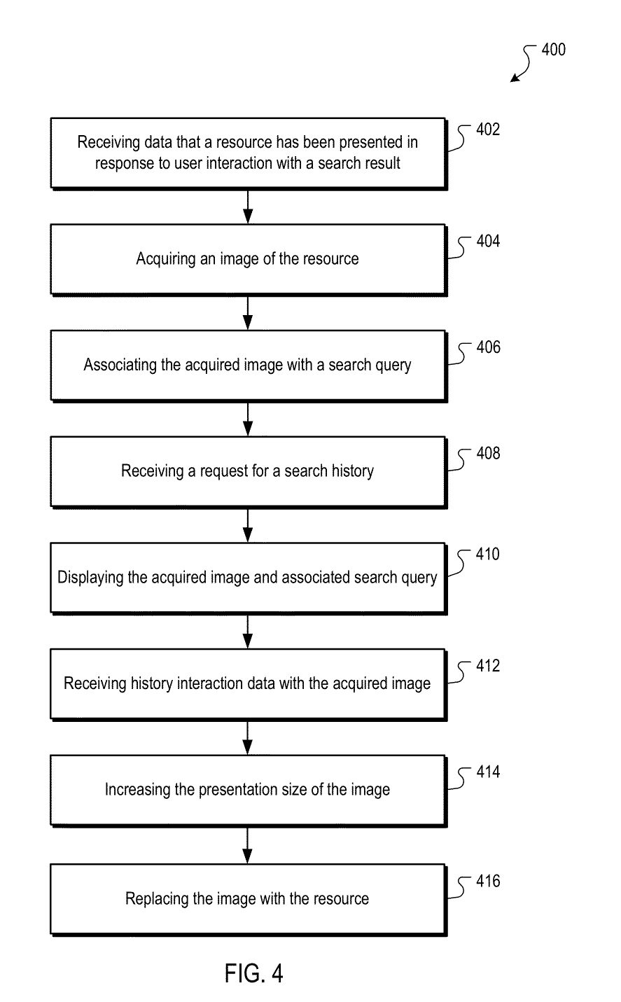

FIG. 4 is a flow chart of an example process 400 for providing a visual search history to a user. Although the process is illustrated as a series of method steps performed by or on a user device, it will be understood that in some implementations, certain steps may be performed away from the device by other components on the network, such as a web server with the ability to index content and maintain a cache of images.

Presentation data is received, where the presentation data indicates that a resource has been presented in response to user interaction with a search result (402). In some implementations, the user interaction and corresponding presentation occurs on a mobile device that may include a touch interface. The device may be network-capable such that the query can be sent to a search system for processing and search results can be received in response to the request. These search results can reference resources that are considered relevant to the user's search query. Generally, more relevant search results are displayed earlier on the page (e.g., higher on the page), although many factors contribute to the order in which results are presented.

When a user selects (i.e., interacts with) a search result that was presented in response to the search request and that corresponds to a resource, the device receives and renders the resource, and in turn, displays the resource to the user. If the resource is a web page associated with a website, the device may respond to input from the user by presenting further content on the website and other linked sites, by returning to the device page to make available other results, or by submitting additional search queries.

An image of the resource is acquired in response to receiving the presentation data (404). Again, this may be carried out by the same device that presents the search results and the resource to the user. Acquisition of the image may occur when the resource is considered all or mostly rendered, as indicated by the presentation data, so that the image substantially matches what the user sees when the device displays it.

In some implementations, the presentation data is received in response to determining that the resource was fully rendered and presented (i.e., at least a threshold portion of the resource was rendered and presented) by the user device. For example, the receipt of the presentation data may be conditioned on 90% of the resource being rendered by the user device and/or the amount of resource presented filling at least 90% of the available display area (e.g., a browser window). Thus, if the user aborts the loading of the page such that it does not completely render, an image may not be acquired. The device may acquire the image by generating it, such as by producing a screen capture image of the rendered (or mostly rendered) resource.

In some implementations, presentation data is received each time that a resource is presented, and an image of each resource can be acquired in response to receipt of the presentation data. For example, following user interaction with an initial search result, the resource that is referenced by that search result can be presented by the device, and an image of that resource can be acquired in response to receipt of the presentation data indicating that the resource was presented. Following user interaction with the first search result, the user may request additional resources through interaction with elements on the presented resource and/or selecting additional search results from the search results page.

In response to the request for the additional resource, the additional resource can be presented by the device, and additional presentation data may be received indicating that the additional resource was presented at the device. Receipt of the additional presentation data can cause the device to acquire an image of the additional resource.

The acquired image is associated with a search query (406). The search query with which the acquired image is associated is the search query for which the search result was provided. The acquired image can be associated with the search query, for example, by being indexed according to and/or stored with a reference to the search query. The acquired image and/or associated search query may be stored in the local memory of the device, or may be stored elsewhere and retrieved over a network upon request. Other information about the resource and the users' access of the resource—such as the rank of the resource's search result among the search results, the time that the resource was accessed by the user, and the title and link of the resource—may also be recorded and included along with the image and search query. This information may collectively form an object or record in a database of similar records associated with the user's search history.

As described above, additional images may be acquired through user interaction with multiple search results and/or requests for resources that are requested subsequent to interaction with one of the search results. Each of the additional images that is acquired can also be associated with the search query, such that a per-query browsing history can be maintained.

A request for a search history for the user device is received (408). The request may be received, in response to user interaction with the device, for example, by interacting with a visual search history presentation as described above. For example, from a search results page, the search history may be available by swiping from the left side of the page to the right, visually dragging the edge of the page over in order to reveal text related to instructions for obtaining a visual search history. The device may detect the swipe as multiple sequential points of contact on the touch screen moving between the left edge and a point further to the right.

The acquired image is displayed, as well as the associated search query (410). In some implementations, the acquired image and associated search query are displayed in response to receipt of the request for the search history. Other information associated with the resource may also be displayed with the acquired image and the associated search query. Where the image and related data are stored and indexed locally, display of the acquired image and associated search query may require little or no network communication, as the acquired image and associated search query are locally retrieved and displayed on the device. This image and resource may again be displayed in the context of other images and resources; a user interface may allow for visual movement of the image in the context of other images in order to locate the desired resource. Once the image depicting the resource is located, a user may interact with the image in order to request presentation of that resource.

In some implementations, history interaction data indicative of user interaction with the acquired image is received (412). The user interaction with the acquired image can be, for example, a click on the image, a pointer contacting a touch screen location at which the image is presented, or another interaction with the image that causes the device to present the associated resource again. Requesting the resource may require communication over the network, and then receiving data and rendering the resource may take some amount of time. While these processes are taking place, the image may be used as a placeholder.

The presentation size of the image is increased (414). In some implementations, the presentation size of the image is increased to fill the area of the browser or search client, and may substantially match the size and position of the rendered resource. By doing so, the image may smooth the transition to the rendered resource.

Because the image is not itself the rendered resource, it is generally not interacted with in the same ways as the rendered resource may be able to be interacted with, particularly if the resource includes hypertext or other interactive elements. Therefore, in some implementations, the image may be modified in some way to visually differentiate it from the resource. For example, the image colors may be muted, or some highlighting or other border effect may be added to the image.

The image is replaced with the resource (416). This may be done in response to determining that the resource has been sufficiently rendered. In some implementations, a predetermined threshold value may be used; the replacement occurs when the percentage of the resource that has been rendered exceeds a predetermined amount, or when some other variable used to represent how much of the resource has been rendered reaches the threshold. A time limit may also be employed so that the replacement occurs after a set interval of time has elapsed even if the amount rendered has not yet reached the established threshold amount by that time. Transitional effects may or may not be used to switch between the image and the rendered resource.

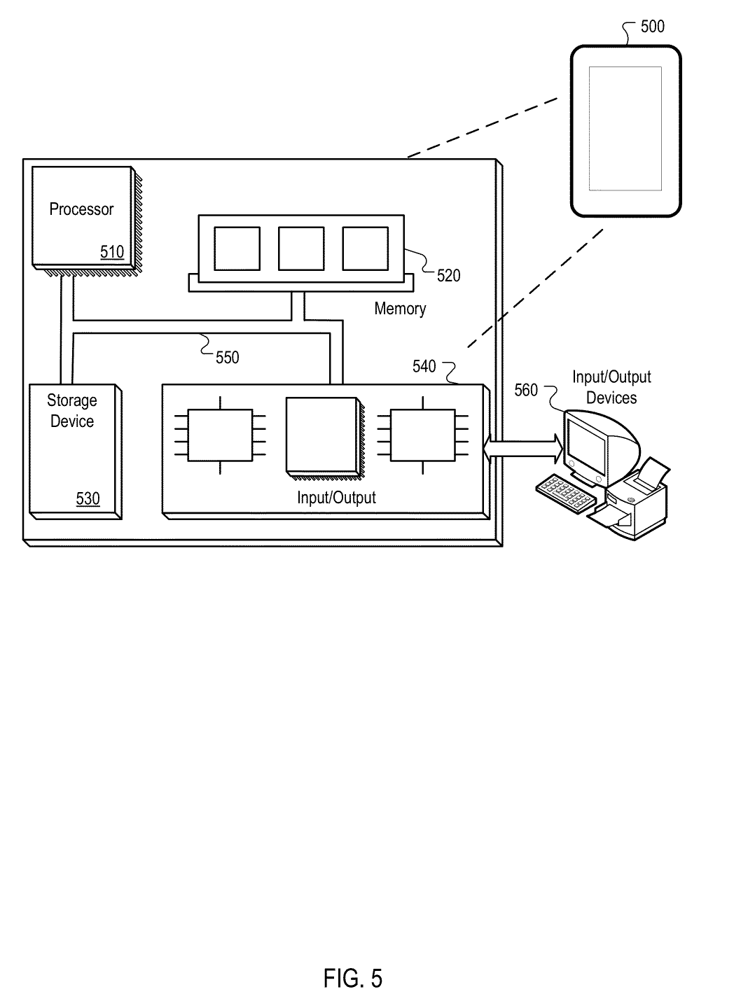

FIG. 5 is block diagram of an example computer system 500 that can be used to perform operations described above. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, a storage device that is shared over a network by multiple computing devices (e.g., a cloud storage device), or some other large capacity storage device.

The input/output device 540 provides input/output operations for the system 500. In one implementation, the input/output device 540 can include one or more of a network interface devices, e.g., an Ethernet card, a serial communication device, e.g., and RS-232 port, and/or a wireless interface device, e.g., and 802.11 card. In another implementation, the input/output device can include a touch screen interface to receive input data and display data to the user, e.g., a tablet computer or mobile communications device. Other implementations, however, can also be used, such as a keyboard, printer, and display devices 560, set-top box television client devices, etc.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving presentation data indicating that a resource has been presented by a user device, the resource having been presented in response to user interaction with a search result that referenced the resource;
in response to receipt of the presentation data, acquiring an image of the resource;
associating the acquired image with a search query for which the search result was provided;
receiving a request for a search history for the user device; and
in response to receipt of the request, displaying the acquired image and the associated search query.

2. The method of claim 1 further comprising:
receiving additional presentation data indicating that an additional resource has been presented by the user device;
in response to receipt of the additional presentation data, acquiring an additional image of the additional resource;
associating the additional image with the search query; and
in response to receipt of the request, displaying a visual grouping of images associated with the search query, the visual grouping including the acquired image and a graphic indicative of the additional image.

3. The method of claim 2, further comprising:
in response to user interaction with the visual grouping of images, displaying at least the acquired and additional images individually.

4. The method of claim 1, further comprising:
receiving history interaction data indicating that user interaction with the acquired image has occurred;
in response to receipt of the history interaction data:
increasing a presentation size of the acquired image; and
rendering at least a portion of the resource;
determining that at least a threshold portion of the resource has been rendered; and
in response to the determination, replacing the image with the resource.

5. The method of claim 4, further comprising:
modifying the image to be visually distinct from the rendered resource.

6. The method of claim 1, wherein receiving a request for the search history comprises determining that a user swipe occurred during a presentation of search results, the determination that the user swipe has occurred being based, at least in part, on detection of a pointer at multiple locations along a path that extends from a first display location to a second display location.

7. The method of claim 1, further comprising:
determining that the resource was fully rendered and presented by the user device; wherein
receiving the presentation data comprises receiving the presentation data in response to the determination that the resource was fully rendered and presented by the user device.

8. A system comprising:
a display in which search results are presented to a user;
one or more processors configured to determine that user interaction with the display has occurred, the one or more processors further configured to perform operations comprising:
receiving presentation data indicating that a resource has been presented by a user device, the resource having been presented in response to user interaction with a search result that referenced the resource;
in response to receipt of the presentation data, acquiring an image of the resource;
associating the acquired image with a search query for which the search result was provided;
receiving a request for a search history for the user device; and
in response to receipt of the request, displaying the acquired image and the associated search query.

9. The system of claim 8, wherein the one or more processors are configured to perform operations further comprising:
receiving additional presentation data indicating that an additional resource has been presented by the user device;
in response to receipt of the additional presentation data, acquiring an additional image of the additional resource;
associating the additional image with the search query; and
in response to receipt of the request, displaying a visual grouping of images associated with the search query, the visual grouping including the acquired image and a graphic indicative of the additional image.

10. The system of claim 9, wherein the one or more processors are configured to perform operations further comprising:
in response to user interaction with the visual grouping of images, displaying at least the acquired and additional images individually.

11. The system of claim 8, wherein the one or more processors are configured to perform operations further comprising:
receiving history interaction data indicating that user interaction with the acquired image has occurred;
in response to receipt of the history interaction data:
increasing a presentation size of the acquired image; and
rendering at least a portion of the resource;
determining that at least a threshold portion of the resource has been rendered; and
in response to the determination, replacing the image with the resource.

12. The system of claim 11, wherein the one or more processors are configured to perform operations further comprising:
modifying the image to be visually distinct from the rendered resource.

13. The system of claim 8, wherein receiving a request for the search history comprises determining that a user swipe occurred during a presentation of search results, the determination that the user swipe has occurred being based, at least in part, on detection of a pointer at multiple locations along a path that extends from a first display location to a second display location.

14. The system of claim 8, wherein the one or more processors are configured to perform operations further comprising:
determining that the resource was fully rendered and presented by the user device; wherein
receiving the presentation data comprises receiving the presentation data in response to the determination that the resource was fully rendered and presented by the user device.

15. A non-transitory computer storage medium encoded with a computer program, the program comprising instructions that when executed by data processing apparatus cause the data processing apparatus to perform operations comprising:
receiving presentation data indicating that a resource has been presented by a user device, the resource having been presented in response to user interaction with a search result that referenced the resource;
in response to receipt of the presentation data, acquiring an image of the resource;
associating the acquired image with a search query for which the search result was provided;
receiving a request for a search history for the user device; and
in response to receipt of the request, displaying the acquired image and the associated search query.

16. The computer storage medium of claim 15, wherein the program includes instructions that when executed by the data processing apparatus cause the data processing apparatus to perform operations further comprising:
receiving additional presentation data indicating that an additional resource has been presented by the user device;
in response to receipt of the additional presentation data, acquiring an additional image of the additional resource;
associating the additional image with the search query; and
in response to receipt of the request, displaying a visual grouping of images associated with the search query, the visual grouping including the acquired image and a graphic indicative of the additional image.

17. The computer storage medium of claim 16, wherein the program includes instructions that when executed by the data processing apparatus cause the data processing apparatus to perform operations further comprising:
in response to user interaction with the visual grouping of images, displaying at least the acquired and additional images individually.

18. The computer storage medium of claim 15, wherein the program includes instructions that when executed by the data processing apparatus cause the data processing apparatus to perform operations further comprising:
receiving history interaction data indicating that user interaction with the acquired image has occurred;
in response to receipt of the history interaction data:
increasing a presentation size of the acquired image; and
rendering at least a portion of the resource;
determining that at least a threshold portion of the resource has been rendered; and
in response to the determination, replacing the image with the resource.

19. The computer storage medium of claim 18, wherein the program includes instructions that when executed by the data processing apparatus cause the data processing apparatus to perform operations further comprising:
modifying the image to be visually distinct from the rendered resource.

20. The computer storage medium of claim 15, wherein receiving a request for the search history comprises determining that a user swipe occurred during a presentation of search results, the determination that the user swipe has occurred being based, at least in part, on detection of a pointer at multiple locations along a path that extends from a first display location to a second display location.

21. The computer storage medium of claim 15, wherein the program includes instructions that when executed by the data processing apparatus cause the data processing apparatus to perform operations further comprising:
determining that the resource was fully rendered and presented by the user device; wherein
receiving the presentation data comprises receiving the presentation data in response to the determination that the resource was fully rendered and presented by the user device.
